(19) United States
(12) Patent Application Publication
(10) Pub. No.: US 2016/0309687 A1
(43) Pub. Date: Oct. 27, 2016

(54) FISHING LURE

(71) Applicant: MEGABASS INC., Hamamatsu-shi (JP)

(72) Inventor: Koichi ITO, Hamamatsu-shi (JP)

(73) Assignee: MEGABASS INC., Hamamatsu-shi (JP)

(21) Appl. No.: 15/009,065

(22) Filed: Jan. 28, 2016

(30) Foreign Application Priority Data
Apr. 21, 2015 (JP) 2015-086848

(51) Int. Cl. A01K 85/00

(52) U.S. Cl. CPC A01K 85/00

(57) ABSTRACT

A fishing lure has a lip on a distal end portion of a lure body. The lure body has a hollow wall structure formed to have an appearance form of small fish. The fishing lure includes a spindle disposed over in the lure body, an arm swingably supported at least in the right and left direction with respect to a fulcrum set on the spindle, and a weight ball mounted on the end part of the arm. The weight ball is movable in a pendulum manner at least in the right and left direction via the arm in the lure body. The weight ball contacts the right and left inner wall surfaces of the lure body.

### CROSS-REFERENCE TO RELATED APPLICATIONS

This application is based upon and claims the benefit of priority of the prior Japanese Patent Application No. 2015-086848, filed on Apr. 21, 2015, the entire contents of which are incorporated herein by reference.

### BACKGROUND OF THE INVENTION

1. Field of the Invention

The present invention relates to a fishing lure, in particular, a fishing lure that is configured to generate a sound providing an excellent appealing effect to fish.

2. Description of the Related Art

In lure fishing, there has been provided lures with various forms and ideas corresponding to the kind of target fish and similar factor. For example, in the case of large-sized target fish, what is called a fish eater, that eats mainly small fish as the normal diet, the lure with the shape imitating the small fish is used for the fishing. To lure the target fish, that is, to obtain a fish-attracting effect strongly appealing to the target fish, the lures with various shapes, colors, and similar element have been provided.

The appealing effect to the target fish in this type of lure is not only by the configuration but a lure that generates a sound with the aim for the effect to promote the preying of bass has been provided.

Specifically, for example, a lure disclosed in Patent Document 1 is a lure for jigging fishing. The lure is sunk deeply and danced in a vertical direction. The lure is formed of solid metal and has an appearance of an artificial bait.

Patent Document 1: Japanese Laid-open Patent Publication No. 2008-182994

However, it is not necessarily easy for the conventional fishing lure to generate the sound with the high appealing effect to the target fish.

### SUMMARY OF THE INVENTION

The present invention has been made in view of the above-described problems, and it is an object of the present invention to provide a fishing lure that generates a sound effectively to provide an excellent appealing effect to fish.

The fishing lure of the present invention is a fishing lure with a lip on the distal end portion of a lure body. The lure body has a hollow wall structure formed to have an appearance form of small fish. The fishing lure includes a spindle disposed over in the lure body, an arm swingably supported at least in the right and left direction with respect to a fulcrum set on the spindle, and a weight ball mounted on an end part of the arm. The weight ball is movable in a pendulum manner at least in the right and left direction via the arm in the lure body. The weight ball is configured to contact the right and left inner wall surfaces of the lure body.

In the fishing lure of the present invention, the spindle has a fulcrum disposed offset forward with respect to an action fulcrum of a wobbling action of the fishing lure.

In the fishing lure of the present invention, the arm is turnably supported around the fulcrum of the spindle.

In the fishing lure of the present invention, the arm is formed of an elastic member with a base end of the arm secured to the fulcrum of the spindle, and the arm is swingable in a vertical direction.

### BRIEF DESCRIPTION OF THE DRAWINGS

FIG. 1 is a side view illustrating an exemplary internal structure of a fishing lure according to an embodiment of the present invention;

FIG. 2 is a top view illustrating the exemplary internal structure of the fishing lure according to the embodiment of the present invention;

FIG. 3 is a top view illustrating a wobbling action of the fishing lure according to the embodiment of the present invention;

FIG. 4 is a top view schematically illustrating a behavior of a hydraulic pressure change in a wobbling action of the fishing lure according to the embodiment of the present invention;

FIG. 5 is a side view illustrating an exemplary internal structure of a lure as a comparative example of the present invention;

FIG. 6 is a top view illustrating the exemplary internal structure of the lure as the comparative example of the present invention;

FIG. 7 is a top view illustrating a wobbling action of the lure as the comparative example of the present invention; and

FIG. 8 is a side view illustrating an exemplary internal structure of a fishing lure according to a second embodiment of the present invention.

### DETAILED DESCRIPTION OF THE PREFERRED EMBODIMENTS

The following describes preferred embodiments of a fishing lure according to the present invention in detail based on the attached drawings.

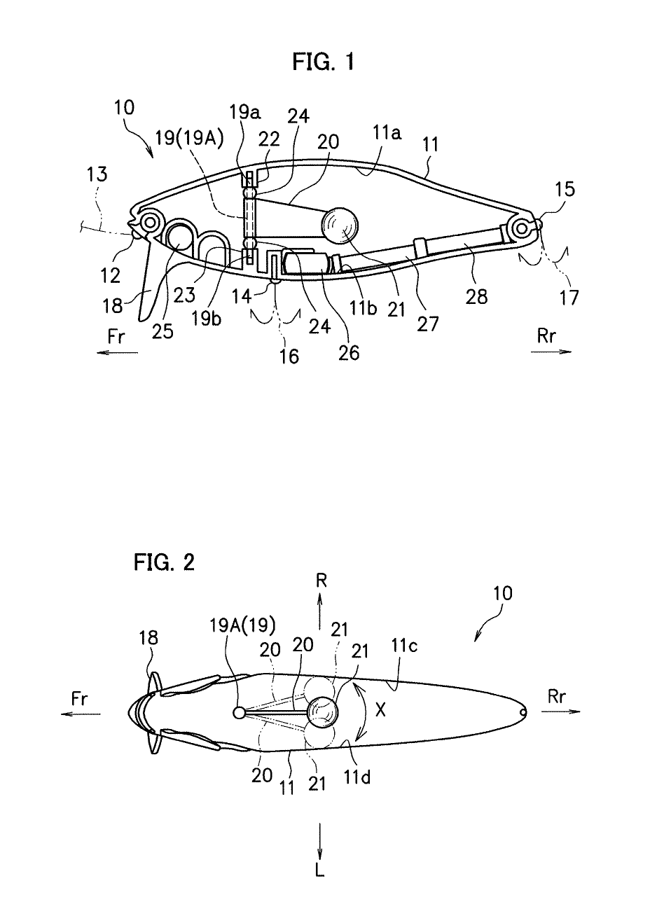

The following describes preferred embodiments of the fishing lure according to the present invention based on the drawings. FIG. 1 is a side view illustrating an exemplary internal structure of a fishing lure 10 in the embodiment. FIG. 2 is a top view of this fishing lure 10. In the drawings used for the following description, including FIG. 1 and FIG. 2, as necessary, an arrow Fr indicates forward and an arrow Rr indicates backward, respectively. An arrow R indicates the right-side side portion, and an arrow L indicates the left-side side portion, respectively.

In FIG. 1 and FIG. 2, the fishing lure 10 includes a lure body 11 formed to have an appearance shape imitating small fish. This lure body 11 is made of a synthetic resin as the material (ABS resin or similar material is preferable, the other resins are applicable). In this case, two of a right body half and a left body half, into which the lure body 11 is divided along the center in the longitudinal direction (the front-rear direction), are brought in contact mutually to be integrated. This causes the lure body 11 to have the hollow wall structure.

The fishing lure 10 includes an eyelet 12 that is disposed near the distal end portion of the lure body 11. In this example, the eyelet 12 is disposed on the inferior surface side of the distal end portion of the lure body 11. To the eyelet 12, a fishing line or a line 13 is attached. Further, the fishing lure 10 includes hook hangers 14 and 15. To the hook hangers 14 and 15, a front hook 16 and a rear hook 17 (fishhook) are hooked via split rings (not illustrated) respectively. The fishing lure 10 includes a lip (submerging plate) 18 disposed on the lower side near the distal end portion of the lure body 11. The lip 18 is formed in a thin plate-shape. The lip 18 is disposed to project downward with a comparatively large inclination angle (approximately 60°, for example) with respect to the lure body 11. Pulling the line 13 attached to the eyelet 12 gives water flow resistance to the lip 18. This ensures the fishing lure 10 to take a swimming posture, for example, inclining forward appropriately.

The fishing lure 10 of the present invention includes a spindle 19, an arm 20, and a weight ball 21. The spindle 19 is disposed over in the lure body 11. The arm 20 is swingably supported at least in the right and left direction with respect to a fulcrum 19A, which is set on the spindle 19, (or spindle line). The weight ball 21 is mounted on an end part of the arm 20.

Specifically, as illustrated in FIG. 1, the fishing lure 10 includes supporting portions 22 and 23 that are respectively predetermined portions on an upper inner wall surface 11a (back portion side of real fish) and a lower inner wall surface 11b (abdomen side of real fish) of the lure body 11. To the supporting portions 22 and 23, an upper end portion 19a and a lower end portion 19b of the spindle 19 are coupled respectively. The spindle 19 is preferably constituted of a metallic rod-shaped member, and arranged at the center in the right and left direction. The spindle 19 may be formed of a synthetic resin material. In this embodiment, the spindle 19 is supported in a vertical direction by the supporting portions 22 and 23. Mounting beads 24 on the upper and lower sides of the arm 20 can make the arm 20 move smoothly.

The arm 20 is preferably constituted of a metallic thin plate member. The arm 20 extends backward from the spindle 19, and is turnably supported around the fulcrum 19A. The arm 20 can be formed of the synthetic resin material. In this case, the arm 20 is configured as a reflective plate to have a reflection function. This achieves the movement of the arm 20 alike to the movement of real fish internal organs, especially when the lure body 11 is colored around the abdomen by a clear color. That is, making the arm 20 movable provides a more distinctive flushing effect. In the supporting structure for the arm 20 by the spindle 19, the arm 20 has an insertion hole, through which the spindle 19 is inserted, on the front end. Via the insertion hole, the arm 20 is turnable with respect to the fulcrum 19A without looseness.

The weight ball 21 is preferably constituted of a metallic sphere with large specific gravity such as lead, tin, or similar metal. The weight ball 21 is secured on the end part of the arm 20. The weight ball 21 may be constituted of other metal or similar material with physical properties equal to lead, tin, and similar metal. Making the weight ball 21 heavy acts effectively to make the collision sound in high decibel when the weight ball 21 contacts the inner wall surface of the lure body 11. As the size of the weight ball 21, the diameter is preferably equal to or more than 7 mm. This acts effectively to make the collision sound in low frequency when the weight ball 21 contacts the inner wall surface of the lure body 11.

As illustrated in FIG. 2, via the arm 20, the weight ball 21 is movable in a pendulum manner in the right and left direction with respect to the fulcrum 19A (arrow X in FIG. 2), and configured to contact a right inner wall surface 11c and a left inner wall surface lid of the lure body 11. In this case, the weight ball 21 is brought in a point contact with the right inner wall surface 11c and the left inner wall surface lid of the lure body 11 in a clean hit manner. This acts effectively to make the collision sound in high decibel when the weight ball 21 contacts the inner wall surface of the lure body 11.

Further, as illustrated in FIG. 1, the lure body 11 may include a plurality of metallic weights 25, 26, 27, 28 and similar weight on the abdomen side. In this case, for example, the weights 25 and 26 may be made of lead, and the weights 27 and 28 may be made of stainless steel. These weights 25 to 28 are housed in a weight room or guided by a guide rib.

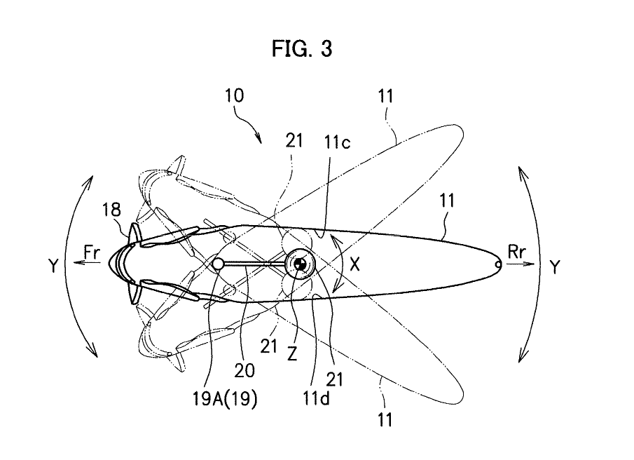

Here, FIG. 3 schematically illustrates a wobbling action of the fishing lure 10 of the present invention. In this wobbling action, the fishing lure 10 moves around an axis passing through the lure body 11 in the vertical direction (referred to as a wobbling axis Z) during swimming as an arrow Y in FIG. 3. The wobbling action corresponds to what is called a yawing action. The fulcrum 19A of the spindle 19 is disposed offset ahead of the wobbling axis Z as an action fulcrum of the wobbling action of the fishing lure 10. Setting the fulcrum 19A of the spindle 19 in this way ensures the weight ball 21 to move to right and left via the arm 20 in the lure body 11 interlocking with the wobbling action of the fishing lure 10.

In the above-described case, the weight ball 21 can function as what is called a balance weight to characterize the fishing lure 10 in the swimming posture and similar feature. In this case, the fishing lure 10 of the present invention does not include a housing portion, a division wall, a rib, or similar portion to house or guide the weight ball 21 in the lure body 11 as much as possible. This prevent the division wall and similar portion from absorbing the collision sound of the weight ball 21 against the inner wall surface of the lure body 11 in the lure body 11. This acts effectively to make the collision sound in high decibel.

The fishing lure 10 of the present invention employs what is called a pendulum sound system to generate a high decibel and low frequency sound in a constant period and stably. The high decibel and low frequency sound with large volume in a low tone has efficacy as follows. Fish sharply perceives a surrounding low frequency sound and a change of hydraulic pressure and water flow by the lateral-line organ. The fishing lure 10 of the present invention generates the high decibel and low frequency sound in the constant period and stably. This ensures to stimulate the lateral-line organ of fish excessively to improve the biting rate by intimidation attacks substantially. Thus, the fishing lure 10 of the present invention can improve the biting rate by equal to or more than 20% compared to a conventional lure with a sliding method described later.

The pendulum sound system according to the present invention can be mounted to apply to the fishing lure 10 for the wobbling action. This ensures to provide a synergetic effect of the change in the hydraulic pressure with the high decibel and low frequency sound, which are caused by the wobbling action, to improve the biting rate substantially.

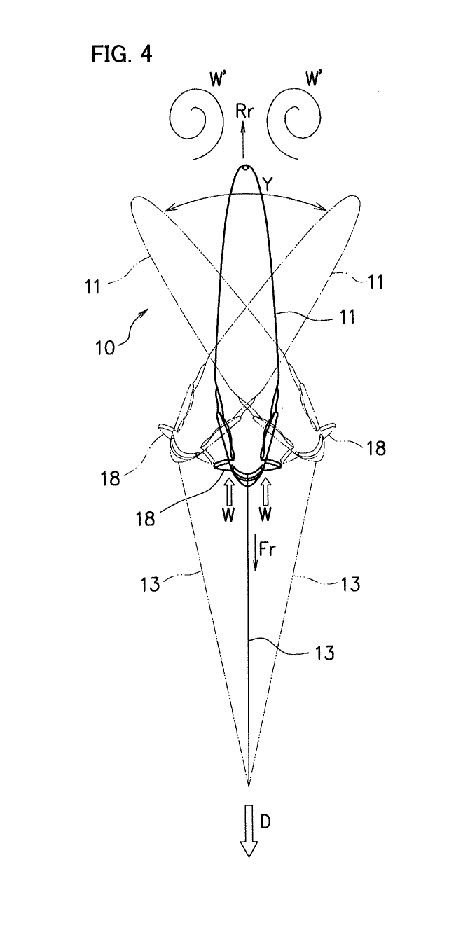

Here, FIG. 4 schematically illustrates a behavior of a hydraulic pressure change by the wobbling action. In causing the fishing lure 10 to take the wobbling action, pulling the line 13 (arrow D in FIG. 4) gives the lip 18 a water flow W. This makes the fishing lure 10 take a turning action around the action fulcrum of the wobbling action (arrow Y in FIG. 4). Then, as illustrated in FIG. 4, the turning action of the fishing lure 10 stirs the water around the rear portion of the lure body 11 to generate a stirring flow W′. This generates the change of the hydraulic pressure at the rear of the fishing lure 10.

Fish can sharply perceive the change of the hydraulic pressure and the water flow in addition to the low frequency sound by the lateral-line organ. Generating the high decibel and low frequency sound and the change of the hydraulic pressure simultaneously stimulates the lateral-line organ of fish more strongly. This ensures to maximally improve the biting rate by the intimidation attacks.

Further, in the fishing lure 10 of the present invention, when the arm 20 is configured as a reflective plate, the fishing lure 10 can further provide a superimposed action by a specific flushing effect in addition to the respective effect of the high decibel and low frequency sound and the change of the hydraulic pressure, and the synergetic effect of the high decibel and low frequency sound with the change of the hydraulic pressure.

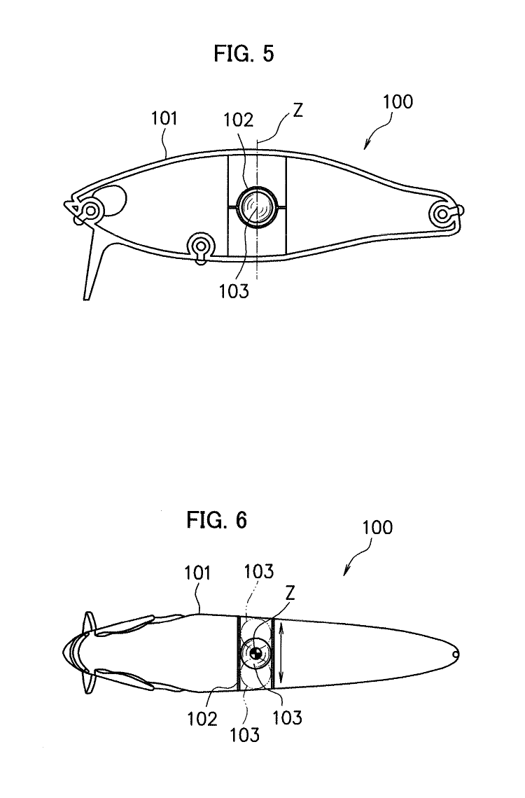

Here, a description will be given of an exemplary conventional lure in relation to the fishing lure 10 of the present invention. FIG. 5 to FIG. 7 illustrate a conventional lure 100. The following describes the main portions only. The lure 100 includes a guide 102 formed between right and left inner wall surfaces in a lure body 101 of the lure 100. In this guide 102, a weight or a weight ball 103 is housed movable sliding in the right-left direction (arrow Y in FIG. 6). In this case, as illustrated in FIG. 5, the guide 102 is disposed in the center portion in the up-down direction and the right-left (front-rear) direction of the lure body 101.

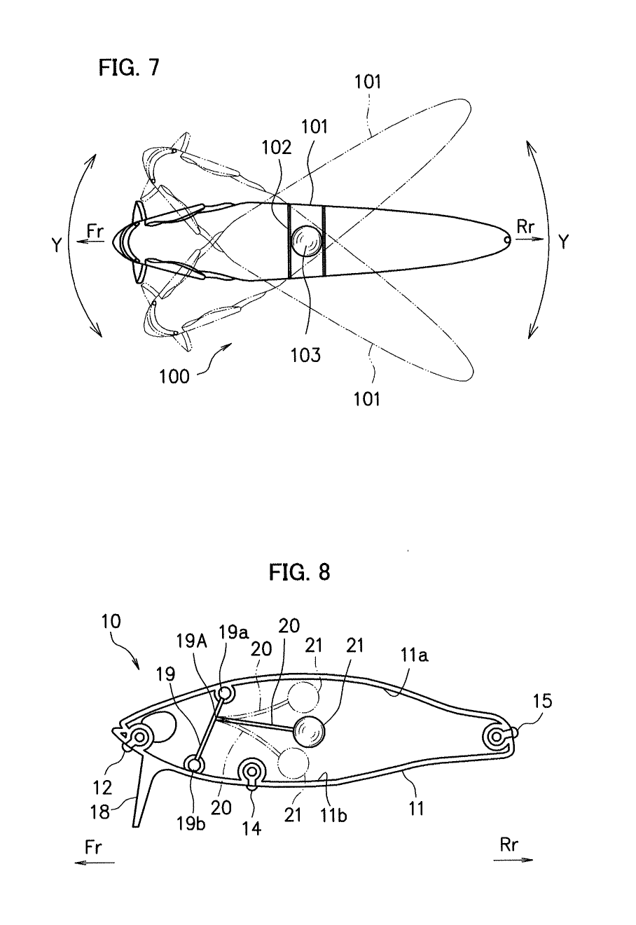

In the conventional lure 100, the action fulcrum (wobbling axis Z) of the wobbling action correspondingly matches to the position of the guide 102, which houses the weight ball 103, actually. Then, when the lure 100 acts as an arrow Y in FIG. 7 in the wobbling action, the weight ball 103 has a difficulty to move to right and left. This prevents the weight ball 103 from generating an effective collision sound against the right and left inner wall surfaces.

In contrast to this, as described above, in the fishing lure 10 of the present invention, the fulcrum 19A as a swing fulcrum of the weight ball 21 is disposed offset with respect to the action fulcrum (wobbling axis Z) of the wobbling action. This ensures the weight ball 21 to move efficiently in a pendulum manner via the arm 20 in the lure body 11 interlocking with the wobbling action of the fishing lure 10.

Further, a description will be given of a second embodiment of the fishing lure 10 according to the present invention with reference to FIG. 8. Like reference numerals designate substantially identical or corresponding elements in the above-described embodiment. In the second embodiment, as illustrated in FIG. 8, the arm 20 has a base end that is secured to the fulcrum 19A on the spindle 19, and the arm 20 is constituted of an elastic member. This ensures the arm 20 to be swingable to the up-down direction further in addition to the right-left direction. The arm 20 is elastically deformable and formed of steel wire rod and similar member that has the necessary rigidity strength to support the weight ball 21. The other configurations are substantially similar to the first embodiment.

According to the fishing lure 10 in the second embodiment, the weight ball 21 moves to right and left via the arm 20 in the lure body 11 interlocking with the wobbling action of the fishing lure 10. Then, the weight ball 21, which contacts the right inner wall surface 11c and the left inner wall surface lid of the lure body 11, generates the high decibel and low frequency sound.

In addition, the weight ball 21 moves to the up-down direction via the arm 20 in the lure body 11 in the case where the fishing lure 10 takes what is called a pitching action, in which the lure body 11 shakes the head up and down, while the fishing lure 10 is swimming and similar case. Then, the weight ball 21 contacts the upper inner wall surface 11a and the lower inner wall surface 11b of the lure body 11. In this case, the weight ball 21 generates the high decibel and low frequency sound as well.

While the preferred embodiments of the present invention have been described, the present invention is not limited only to the above-described embodiments. Changes and similar modification are possible as necessary.

For example, specific dimensions and similar factor of the arm 20 and the weight ball 21 can be set as necessary corresponding to the fishing lure to which the present invention is applied.

The fulcrum 19A on the spindle 19 in the above-described embodiments may be disposed offset rear of the wobbling axis Z as the action fulcrum of the wobbling action of the fishing lure 10.

According to the present invention, a fishing lure that employs what is called a pendulum sound system is configured to generate a high decibel and low frequency sound in a constant period and stably. The sound stimulates fish to improve the biting rate substantially. This realizes the high fishing result.

Applying the pendulum sound system to the fishing lure that takes the wobbling action provides the synergetic effect of the change of the hydraulic pressure by the wobbling action with the high decibel and low frequency sound. This ensures to improve the biting rate substantially.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A fishing lure with a lip on a distal end portion of a lure body, the lure body having a hollow wall structure formed to have an appearance form of small fish, comprising:
a spindle disposed over in the lure body;
an arm swingably supported at least in a right and left direction with respect to a fulcrum set on the spindle; and
a weight ball mounted on an end part of the arm, wherein
the weight ball is movable in a pendulum manner at least in the right and left direction via the arm in the lure body, and
the weight ball is configured to contact the right and left inner wall surfaces of the lure body.

2. The fishing lure according to claim 1, wherein
the spindle has a fulcrum disposed offset forward with respect to an action fulcrum of a wobbling action of the lure.

3. The fishing lure according to claim 1, wherein
the arm is turnably supported around the fulcrum of the spindle.

4. The fishing lure according to claim 2, wherein
the arm is turnably supported around the fulcrum of the spindle.

5. The fishing lure according to claim 1, wherein
the arm is formed of an elastic member with a base end of the arm secured to the fulcrum of the spindle, and the arm is swingable in an up-down direction.

6. The fishing lure according to claim 2, wherein
the arm is formed of an elastic member with the base end of the arm secured to the fulcrum of the spindle, and the arm is swingable in an up-down direction.
